(19) United States
(12) Patent Application Publication
(10) Pub. No.: US 2015/0189262 A1
(43) Pub. Date: Jul. 2, 2015

(54) IMAGE REPRODUCING APPARATUS AND METHOD, AND COMPUTER-READABLE RECORDING MEDIUM

(71) Applicant: SAMSUNG ELECTRONICS CO., LTD., Suwon-si (KR)

(72) Inventors: Ha-joong Park, Suwon-si (KR); Sung-bin Hong, Yongin-si (KR); Su-hee Kim, Yongin-si (KR)

(21) Appl. No.: 14/533,316

(22) Filed: Nov. 5, 2014

(30) Foreign Application Priority Data
Dec. 30, 2013 (KR) 10-2013-0167509

(51) Int. Cl. H04N 13/04

(52) U.S. Cl. CPC H04N 13/0422; H04N 13/0452

(57) ABSTRACT

An image reproducing method is described. A three-dimensional (3D) image file including a left image and a right image is reproduced. A first channel image is generated from the left image of the 3D image. A second channel image is generated from the right image of the 3D image. The first channel image is combined with the second channel image to generate an output image. The output image is displayed.

### CROSS-REFERENCE TO RELATED PATENT APPLICATION

This application claims the priority benefit of Korean Patent Application No. 10-2013-0167509, filed on Dec. 30, 2013, in the Korean Intellectual Property Office, the disclosure of which is incorporated by reference herein in its entirety.

### BACKGROUND

1. Field

One or more embodiments of the present disclosure relate to an image reproducing apparatus and method, and a computer-readable recording medium.

2. Related Art

Contents including a three-dimensional (3D) image have been widely spread. To capture the 3D image, a 3D image-capable capturing camera is needed, and to reproduce the 3D image, a 3D image-capable reproducing apparatus is needed. Therefore, 3D image contents have a restriction in a sense that they require dedicated hardware for creating and reproducing a 3D image.

### SUMMARY

One or more embodiments of the present disclosure are intended to reproduce a 3D image in an image reproducing apparatus.

One or more embodiments of the present disclosure are intended to improve a color or quality of a 3D image in reproduction of the 3D image.

Additional embodiments will be set forth in part in the description which follows and, in part, will be apparent from the description, or may be learned by practice of the presented embodiments.

According an embodiment, an image reproducing method includes: reproducing a three-dimensional (3D) image file including a left image and a right image, generating a first channel image from the left image of the 3D image, generating a second channel image from the right image of the 3D image, combining the first channel image with the second channel image to generate an output image, and displaying the output image.

The first channel image may be an image representing a red component of the left image, and the second channel image may be an image representing a green component and a blue component of the right image.

A display device for displaying the output image may be a display device for two-dimensional (2D) image reproduction.

The image reproducing method may further include adjusting at least one of a color component and a chroma component of the left image and the right image.

The generating of the output image may include adjusting a weight value for the first channel image and a weight value for the second channel image according to a user setting value, and combining the first channel image with the second channel image based on the adjusted weight values.

The image reproducing method may further include storing the output image.

The storing of the output image may include storing information about the 3D image file, together with the output image.

According to another embodiment, an image reproducing apparatus includes: a three-dimensional (3D) image reproducing unit configured to reproduce a 3D image file including a left image and a right image; an image converting unit configured to generate a first channel image from the left image of the 3D image and generate a second channel image from the right image of the 3D image; an image combining unit configured to combine the first channel image with the second channel image to generate an output image; and a display unit configured to display the output image.

The first channel image may be an image representing a red component of the left image, and the second channel image may be an image representing a green component and a blue component of the right image.

The display unit may be a display unit for two-dimensional (2D) image reproduction.

The image converting unit may adjust at least one of a color component and a chroma component of the left image and the right image.

The image combining unit may adjust a weight value for the first channel image and a weight value for the second channel image according to a user setting value and combine the first channel image with the second channel image based on the adjusted weight values.

The image reproducing apparatus may further include a storing unit configured to store a file of the output image.

The storing unit may store information about the 3D image file, together with the output image.

According to yet another embodiment, there is provided a non-transitory computer-readable recording medium having recorded thereon computer program codes for executing an image reproducing method when the computer program codes are read and executed by a processor, the image reproducing method including: reproducing a three-dimensional (3D) image file including a left image and a right image; generating a first channel image from the left image of the 3D image; generating a second channel image from the right image of the 3D image; combining the first channel image with the second channel image to generate an output image; and displaying the output image.

### BRIEF DESCRIPTION OF THE DRAWINGS

These and/or other embodiments will become apparent and more readily appreciated from the following description of various embodiments, taken in conjunction with the accompanying drawings in which:

FIG. 1 is a block diagram illustrating a structure of an image reproducing apparatus according to an embodiment;

FIG. 2 is a diagram illustrating an image reproducing apparatus according to an embodiment;

FIG. 3 is a diagram illustrating a process of generating a first channel image, a second channel image, and an output image according to an embodiment;

FIG. 4 is a diagram illustrating a process of viewing a generated output image according to an embodiment;

FIG. 5 is a flowchart illustrating an image reproducing method according to an embodiment;

FIG. 6 is a diagram illustrating a process of generating an output image according to another embodiment;

FIGS. 7 and 8 are diagrams illustrating an example of a user interface screen for adjusting a weight value of each color component in an output image according to another embodiment;

FIG. 9 is a diagram illustrating an image reproducing method according to yet another embodiment;

FIG. 10 is a diagram illustrating a structure of an image reproducing apparatus according to yet another embodiment; and

FIG. 11 is a flowchart illustrating an image reproducing method according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Various advantages and features of the present disclosure will become apparent from the embodiments described below in detail with reference to the accompanying drawings. However, the present disclosure is not limited to the disclosed embodiments and may be implemented in different forms. The embodiments are provided to complete the disclosure and to allow those of ordinary skill in the art to fully understand the scope of the present disclosure, and the present disclosure is defined merely by the claims.

Where general terms are used herein, the general terms may be changed according to purposes of those skilled in the art or customs or the appearance of new technologies. In a particular case, terms selected by the applicant may be used and in this case, their meanings will be described in a relevant description part of the present disclosure. Therefore, the terms used herein should be understood on the basis of practical meanings of the terms and contents throughout this specification, not only names of the terms.

When a part “comprises” or “includes” an element, unless otherwise described, the part may further comprise or include other elements, rather than exclude other elements. Terms ‘part’ used in the embodiments means a software or a hardware component such as a field-programmable gate array (FPGA) or an application-specific integrated circuit (ASIC), and a ‘part’ plays a certain role. However, the ‘part’ does not have a meaning limited to software or hardware. The ‘part’ may be configured to be in a storage medium capable of addressing, or may be configured to execute one or more processors. Therefore, as an example, the ‘part’ includes components such as software components, object-oriented software components, class components, and task components, and processes, functions, attributes, procedures, subroutines, segments of a program code, drivers, firmware, a micro code, a circuit, data, a database, data structures, tables, arrays, and variables. Functions provided in components and ‘parts’ may be combined into a smaller number of components and ‘parts’ or may be further separated into additional components and ‘parts’.

Various embodiments will be described in detail with reference to the accompanying drawings. To clarify the present disclosure in the drawings, parts that are not related to the description will be omitted.

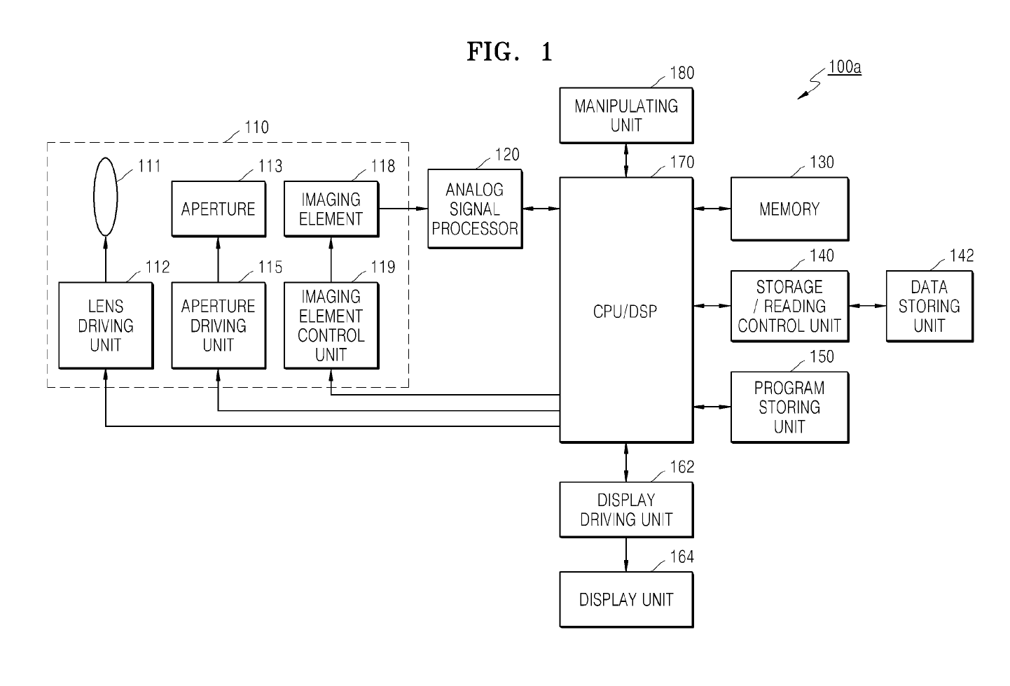

FIG. 1 is a block diagram illustrating a structure of an image reproducing apparatus 100a according to an embodiment.

The image reproducing apparatus 100a according to an embodiment may include a capturing unit 110, an analog signal processor 120, a memory 130, a storage/reading control unit 140, a data storing unit 142, a program storing unit 150, a display driving unit 162, a display unit 164, a central processing unit (CPU)/digital signal processor (DSP) 170, and a manipulating unit 180.

An overall operation of the image reproducing apparatus 100a is controlled by the CPU/DSP 170. The CPU/DSP 170 provides one or more of a lens driving unit 112, an aperture driving unit 115, or an imaging element control unit 119 with one or more control signals for their respective operation.

The capturing unit 110 is a component for generating an image as an electrical signal from incident light. The capturing unit 110 may include a lens 111, the lens driving unit 112, an aperture 113, the aperture driving unit 115, an imaging element 118, and the imaging element control unit 119.

The lens 111 may include multiple groups and multiple sheets of lenses. A position of the lens 111 is adjusted by the lens driving unit 112. The lens driving unit 112 adjusts the position of the lens 111 based on a control signal provided by the CPU/DSP 170.

The amount of opening and closing of the aperture 113 is adjusted by the aperture driving unit 115, and adjusts the amount of light incident to the imaging element 118.

An optical signal passing through the lens 111 and the aperture 113 forms an image of a subject on a light-receiving surface of the imaging element 118. The imaging element 118 may be a charge coupled device (CCD) image sensor or a complementary metal oxide semiconductor (CMOS) image sensor (CIS) that converts an optical signal into an electric signal. The sensitivity of the imaging element 118 may be adjusted by the imaging element control unit 119. The imaging element control unit 119 may control the imaging element 118 based on a control signal automatically generated by a real-time input image signal or a control signal manually input by user's manipulation.

An exposure time of the imaging element 118 is adjusted by a shutter (not shown). Examples of the shutter (not shown) include a mechanical shutter that controls incidence of light by moving a shutter or an electronic shutter that controls exposure by supplying an electrical signal to the imaging element 118.

According to an embodiment, the capturing unit 110 is configured to capture a 3D image. For example, the capturing unit 110 may include a left image lens and a right image lens and may simultaneously or successively capture a left image and a right image.

The analog signal processor 120 performs one or more of noise reduction processing, gain adjustment, waveform standardization, analog-to-digital conversion processing, or other processing, with respect to an analog signal provided from the imaging element 118.

A signal processed by the analog signal processor 120 may be input to the CPU/DSP 170 via the memory 130 or may be directly input to the CPU/DSP 170. Herein, the memory 130 operates as a main memory of the image reproducing apparatus 100a and temporarily stores information that the CPU/DSP 170 uses during its operations. The memory 130 stores programs such as an operating system or an application system for driving or controlling the image reproducing apparatus 100a.

The image reproducing apparatus 100a may include the display unit 164 for displaying an operation state of the image reproducing apparatus 100a and image information obtained by the image reproducing apparatus 100a. The display unit 164 may provide visual information and/or auditory information to a user. To provide the visual information, the display unit 164 may include, for example, a liquid crystal display (LCD) panel, an organic light emitting display (OLED) panel, or the like. The display unit 164 may be a touchscreen capable of recognizing a touch input.

The display driving unit 162 provides a drive signal to the display unit 164.

The CPU/DSP 170 processes an input image signal and controls components based on the processed image signal or an external input signal. The CPU/DSP 170 may perform image signal processing for image quality improvement with respect to input image data, such as noise reduction, gamma correction, color filter array interpolation, color matrix, color correction, or color enhancement. The CPU/DSP 170 generates an image file by compressing image data generated from the image signal processing for image quality improvement, or reconstructs image data from the image file. A compression format of an image may be reversible or irreversible. Examples of a format for a still image may include a Joint Photographic Experts Group (JPEG) format or a JPEG 2000 format. For a moving image, a plurality of frames may be compressed to generate a moving image file according to the Moving Picture Experts Group (MPEG) standard. The image file may be generated, for example, according to the Exchangeable image file format (Exif) standard.

The storing/reading control unit 140 reads data regarding an image from an image file stored in the data storing unit 142, and inputs the read data to the display driving unit 162 via the memory 130 or through another path to allow the image to be displayed on the display unit 164. The data storing unit 142 may be removable or may be permanently mounted on the image reproducing apparatus 100a.

The CPU/DSP 170 may perform one or more of sharpness processing, color processing, blur processing, edge emphasizing, image interpreting, image recognition processing, or image effect processing. As the image recognition processing, face recognition processing or scene recognition processing may be performed. Moreover, the CPU/DSP 170 performs display image signal processing for display on the display unit 164. For example, the CPU/DSP 170 may perform one or more of brightness level adjustment, color adjustment, contrast adjustment, contouring adjustment, screen division, character image generation, or image combination. The CPU/DSP 170 may be connected to an external monitor and may perform predetermined image signal processing to display images on the external monitor. The CPU/DSP 170 may transfer processed image data to the external monitor so that the corresponding images may be displayed on the external monitor.

The CPU/DSP 170 executes a program stored in the memory 130 or includes a separate module to generate a control signal for controlling auto focusing, zoom changing, focus changing, and auto exposure correction for transmission to the aperture driving unit 115, the lens driving unit 112, and the imaging element control unit 119 and to comprehensively control operations of components, such as a shutter or a strobe, included in the image reproducing apparatus 100a.

The manipulation unit 180 is a portion to which the user may input the control signal. The manipulation unit 180 may include various function buttons such as a shutter-release button for inputting a shutter-release signal to expose the imaging element 118 to light during a predetermined time to take a picture, a power button for inputting a control signal for controlling on-off of the power, a zoom button for widening or narrowing a viewing angle based on an input, a mode selection button, and other capturing setting value adjustment buttons. The manipulation unit 180 may be implemented in any form that allows the user to input the control signal thereto, such as a button, a keyboard, a touch pad, a touch screen, or a remote controller.

The image reproducing apparatus 100a illustrated in FIG. 1 and according to the current embodiment is merely an embodiment, and the image reproducing apparatus according to the present disclosure is not limited to this embodiment. That is, the present disclosure is applicable to a personal digital assistant (PDA), a cellular phone, or a computer that is capable of reproducing images stored in a storage medium. Although the image reproducing apparatus 100a is implemented in the form of a capturing apparatus as illustrated in FIG. 1, it is not limited to a structure illustrated in FIG. 1.

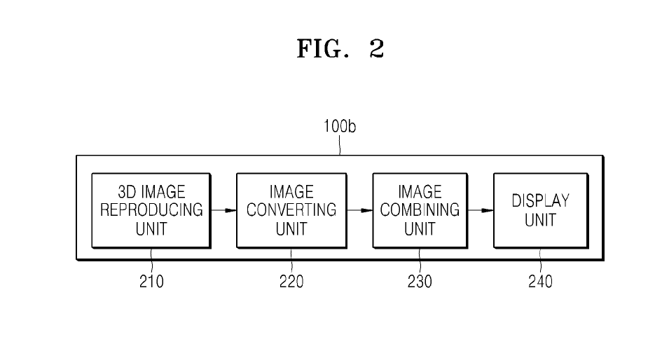

FIG. 2 is a diagram illustrating an image reproducing apparatus 100b according to an embodiment. The image reproducing apparatus 100b according to the current embodiment may include a 3D image reproducing unit 210, an image converting unit 220, an image combining unit 230, and a display unit 240.

According to an embodiment, the 3D image reproducing unit 210, the image converting unit 220, and the image combining unit 230 may be implemented in the CPU/DSP 170 of the image reproducing apparatus 100a according to the embodiment illustrated in FIG. 1. According to an embodiment, the display unit 240 may correspond to the display unit 164 of the image reproducing apparatus 100a according to the embodiment of FIG. 1.

The 3D image reproducing unit 210 reproduces a 3D image file including a left image and a right image. The 3D image file, which is an image file including a left image and a right image, may be, for example, a multi-picture object (MPO) image file. The 3D image reproducing unit 210 decodes the 3D image file to obtain a left image and a right image, and decodes the left image and the right image to obtain RGB images for the left image and the right image.

According to an embodiment, the image reproducing apparatus 100a enters a 3D reproduction mode, and displays 3D image files the user may select as selectable forms. Once the user selects one of the 3D image files, the 3D image reproducing unit 210 reproduces the selected 3D image file.

The image converting unit 220 generates a first channel image for the left image and a second channel image for the right image. For example, the image converting unit 220 converts the RGB images for the left image and the right image to generate the first channel image and the second channel image.

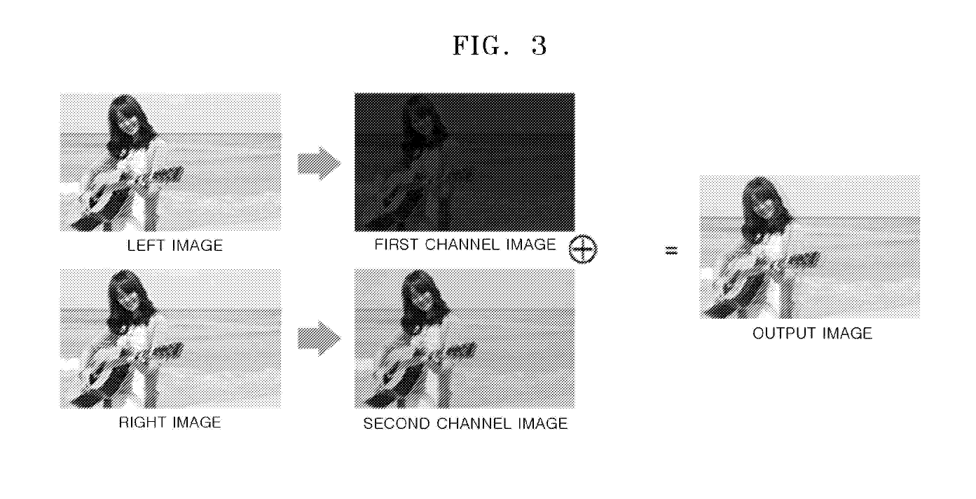

FIG. 3 is a diagram illustrating a process of generating the first channel image, the second channel image, and an output image according to an embodiment.

As illustrated in FIG. 3, the first channel image may be generated from the left image and the second channel image may be generated from the right image. According to an embodiment, the first channel image is an image representing a red component of the left image and the second channel image is an image representing green and blue components of the right image. In this case, the image converting unit 220 extracts the red component from the left image to generate the first channel image as illustrated in FIG. 3. The image converting unit 220 extracts the green component and the blue component from the right image to generate the second channel image. When generating the second channel image, the image converting unit 220 generates a green image representing the green component from the right image and a blue image representing the blue component from the right image and combines the green image with the blue image to generate the second channel image.

Although the first channel image is a red-component image and the second channel image is a green-and-blue-component image in FIG. 3, the first channel image may be the green-and-blue component and the second channel embodiment may be a red-component image. The color components of the first channel image and the second channel image may be changed according to various embodiments.

The image combining unit 230 combines the first channel image with the second channel image to generate an output image. Referring to FIG. 3, the first channel image and the second channel image are combined to generate an output image having parallax.

The image converting unit 220 and the image combining unit 230 may convert and combine the left image and the right image of the 3D image file to generate an output image, for example, in an Anaglyph 3D image form.

The display unit 240 displays the output image.

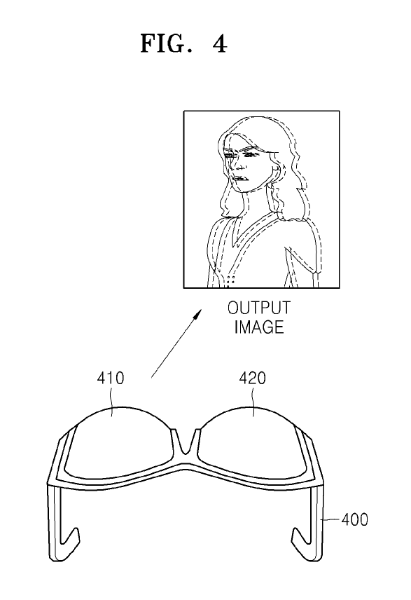

FIG. 4 is a diagram illustrating a process of viewing a generated output image according to an embodiment.

The output image according to the current embodiment may be seen through glasses 400 including a filter passing a color component of the first channel image therethrough in a left-view lens 410 and a filter passing a color component of the second channel image therethrough in a right-view lens 420. When the output image according to the current embodiment is seen through the glasses 400, the first channel image corresponding to a left image included in the 3D image file is recognized by a user's left eye and the second channel image corresponding to a right image included in the 3D image file is recognized by the user's right eye. Thus, the user may recognize the left image and the right image separately through the left eye and the right eye, respectively, thereby recognizing a 3D effect.

As in the embodiment described with reference to FIG. 3, if the first channel image is an image of a red component, the left-view lens 410 may be a lens passing the red component therethrough. If the second channel image is an image of a green component and a blue component, the right-view lens 420 may be a lens passing the green component and the blue component therethrough.

According to embodiments, an image reproducing apparatus that has no display unit for 3D image reproduction may also reproduce a 3D image file to give a 3D effect. A capturing apparatus capable of capturing a 3D image may also have no display unit for 3D image reproduction, and according to the current embodiment, a 3D image may be reproduced using a display unit for 2D image reproduction, thereby improving user convenience.

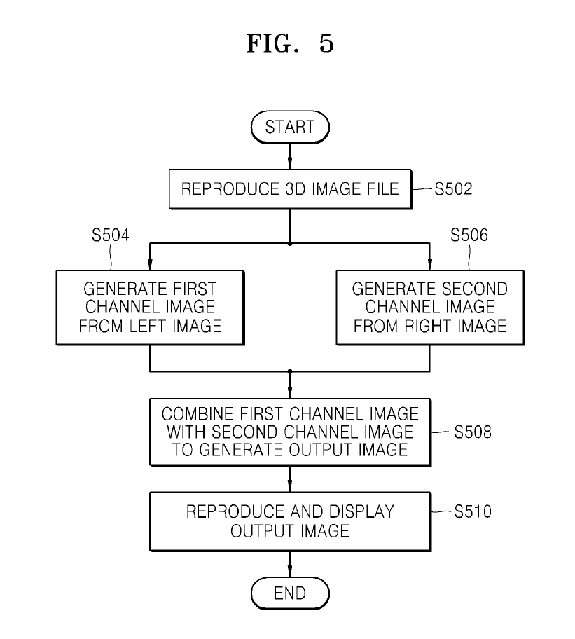

FIG. 5 is a flowchart illustrating an image reproducing method according to an embodiment.

The image reproducing method according to the current embodiment includes obtaining a left image and a right image by reproducing a 3D image file in operation S502. Also, RGB images for the left image and the right image may be obtained.

Next, the image reproducing method includes generating a first channel image from the left image in operation S504 and generating a second channel image from the right image in operation S506. According to an embodiment, the first channel image is an image representing the red component of the left image and the second channel image is an image representing the green component and the blue component of the right image.

Next, the image reproducing method includes combining the first channel image with the second channel image to generate an output image in operation S508.

Then, the image reproducing method includes reproducing and displaying the output image in operation S510.

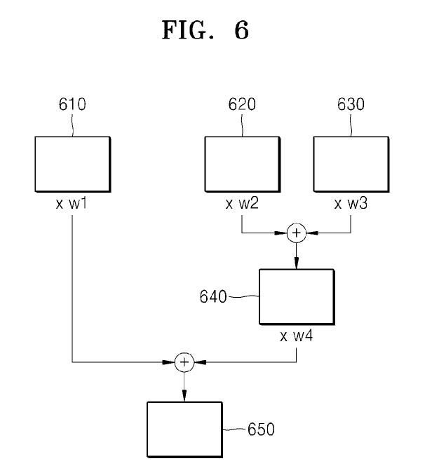

FIG. 6 is a diagram illustrating a process of generating an output image according to another embodiment.

The image combining unit 230 according to the current embodiment adjusts a weight value for the first channel image and a weight value for the second channel image when generating the output image. The image converting unit 220 according to the current embodiment may adjust a weight value for color components included in each image when generating the first channel image and the second channel image.

In FIG. 6, a description will be made using an example where a first channel image 610 is an image representing a red component of a left image and a second channel image 640 is an image representing a green component and a blue component. According to the current embodiment, the image converting unit 220 adjusts a weight value W2 and a weight value W3 for a green-component image 620 and a blue-component image 630, respectively, of a right image when generating the second channel image 640. The image combining unit 230 adjusts a weight value W1 for the first channel image 610 and a weight value W4 for the second channel image when combining the first channel image 610 with the second channel image 640. According to the current embodiment, a weight value for each color component is adjusted to adjust a color of an output image 650.

According to an embodiment, weight value adjustment may be performed based on a user input.

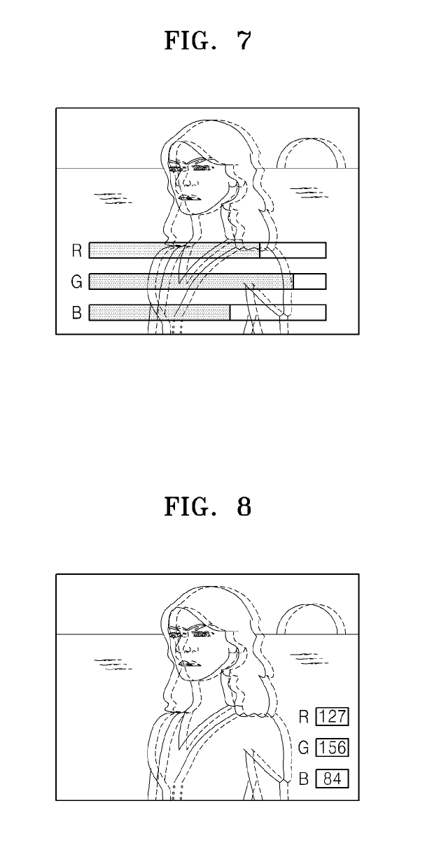

FIGS. 7 and 8 are diagrams illustrating an example of a user interface screen capable of adjusting a weight value of each color component in an output image according to another embodiment.

As shown in FIG. 7, the user adjusts a weight value for a red component R, a weight value for a green component G, and a weight value for a blue component B, thus obtaining an output image having a desired color. In this case, the image converting unit 220 and the image combining unit 230 adjusts the weight value W1 for the red-component image, the weight value W2 for the green-component image, and the weight value W3 for the blue-component image based on a user setting value. Thus, the user may reproduce a 3D image in a desired color through such a user interface. According to an embodiment, when a 3D image is reproduced, a weight value for each color component may be displayed together with the 3D image as illustrated in FIG. 8.

An interface that allows the user to adjust a weight value for each color component may be implemented in the form of a dial, a progress bar, a value adjustment interface, a message, or the like in addition to the example illustrated in FIG. 7. The interface for adjusting a color component may also be expressed in various forms, such as a transparent, opaque, or semi-transparent form.

According to another embodiment, the image converting unit 220 and the image combining unit 230 may give a larger weight value to a color component that is more sensitive in terms of a human visual system (HVS) than those of other color components. For example, the image converting unit 220 and the image combining unit 230 may give a larger weight value to a green component that is sensitive in terms of the HVS than those of the red component and the blue component. The green component may be helpful for relieving eyestrain. Green-based colors are close to natural colors and have lower chroma and brightness than those of red color, such that the green-based colors are recognized well by cones without greatly stimulating rods that recognize light and darkness. Green also occupies the narrowest part of a viewing angle. White is sensed even if deviating from the visual center of the eye, but green cannot be sensed if it is not in the visual center. That is, green around a peripheral view does not stimulate the eyes to the same extent. Thus, green is a color component that may cause fatigue to a user. Considering the human visual characteristics, according to an embodiment, by adjusting a weight value for the red component, a weight value for the green component, and a weight value for the blue component in an output image, the fatigue of the eyes of the user may be minimized and user convenience may be provided. For example, based on the characteristics of a 3D image (for example, a histogram), a weight value for the red component in the first channel image may be set to 0.8, a weight value for the green component in the second channel image may be set to 1.2, and a weight value for the blue component in the second channel image may be set to 1.0.

According to another embodiment, the image converting unit 220 adjusts at least one of a chroma component and a color component of a left image and a right image in a color space. The image combining unit 230 adjusts at least one of a chroma component and a color component of an output image in the color space. According to the current embodiment, the quality of a display image may be improved by adjusting a chroma component and a color component of a left image, a right image, and/or an output image.

According to another embodiment, a chroma component and a color component of at least one of the left image, the right image, and the output image may be adjusted based on the characteristics of the display unit 240. For example, if the display unit 240 includes an organic light emitting display panel or a liquid crystal display panel, the image converting unit 220 and/or the image combining unit 240 may adjust a chroma component and a color component of at least one of a left image, a right image, and an output image based on the characteristics of a display panel included in the display unit 240.

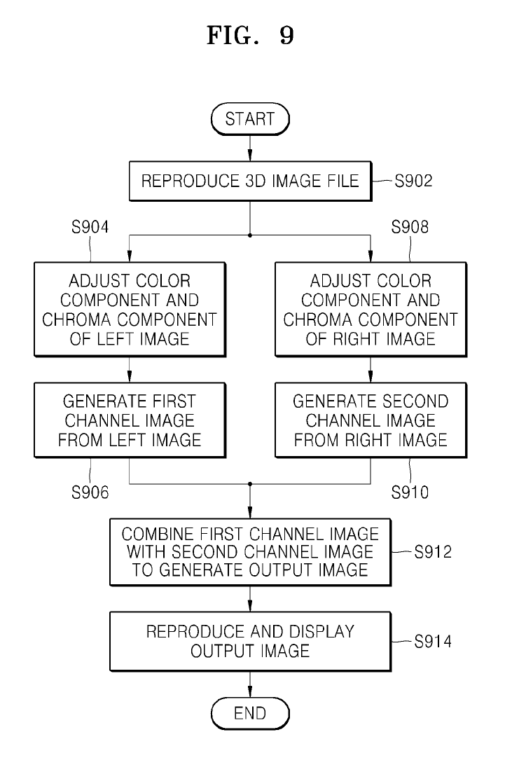

FIG. 9 is a diagram illustrating an image reproducing method according to another embodiment.

The image reproducing method according to the current embodiment includes reproducing a 3D image file to obtain a left image and a right image in operation S902. RGB images for the left image and the right image may also be obtained.

The image reproducing method also includes adjusting a color component and/or a chroma component of the left image in operation S904 and adjusting a color component and/or a chroma component of the right image in operation S908. The image reproducing method also includes generating a first channel image from the left image in operation S906 and generating a second channel image from the right image in operation S910. An order of adjustment of the color component and/or the chroma component (operations S904 and S908) and generation of the first channel image and the second channel image (operations S906 and S910) may be changed according to an embodiment. According to an embodiment, the first channel image is an image representing a red component of the left image and the second channel image is an image representing a green component and a blue component of the right image.

The image reproducing method includes combining the first channel image with the second channel image to generate an output image in operation S912. According to an embodiment, adjustment of a color component and/or a chroma component with respect to the output image may also be performed.

The image reproducing method includes reproducing and displaying the output image in operation S914.

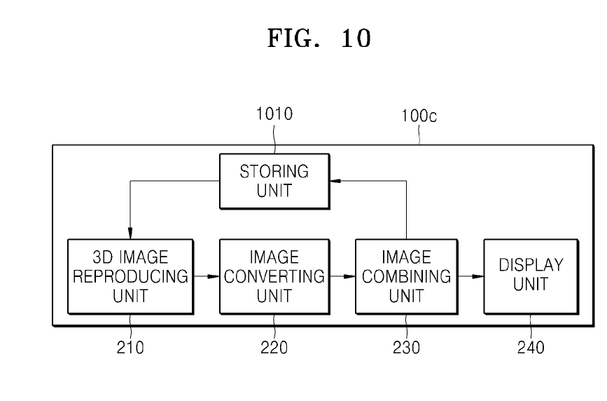

FIG. 10 is a diagram illustrating a structure of an image reproducing apparatus 100c according to another embodiment. The image reproducing apparatus 100c according to the current embodiment may include the 3D image reproducing unit 210, the image converting unit 220, the image combining unit 230, the display unit 240, and a storing unit 1010.

According to an embodiment, the 3D image reproducing unit 210, the image converting unit 220, and the image combining unit 230 may be implemented within the CPU/DSP 170 of the image reproducing apparatus 100a according to the embodiment illustrated in FIG. 1. According to an embodiment, the display unit 240 may correspond to the display unit 164 of the image reproducing apparatus 100a according to the embodiment illustrated in FIG. 1 and the storing unit 1010 may correspond to the data storing unit 142 of the image reproducing apparatus 100a according to the embodiment illustrated in FIG. 1.

The 3D image reproducing unit 210 reproduces a 3D image file including a left image and a right image.

The image converting unit 220 generates a first channel image from the left image and a second channel image from the right image.

The image combining unit 230 combines the first channel image with the second channel image to generate an output image.

The display unit 240 displays the output image.

The storing unit 1010 stores a file of the output image. The image combining unit 230 converts the output image into a JPEG format to generate an image file and outputs the image file to the storing unit 1010.

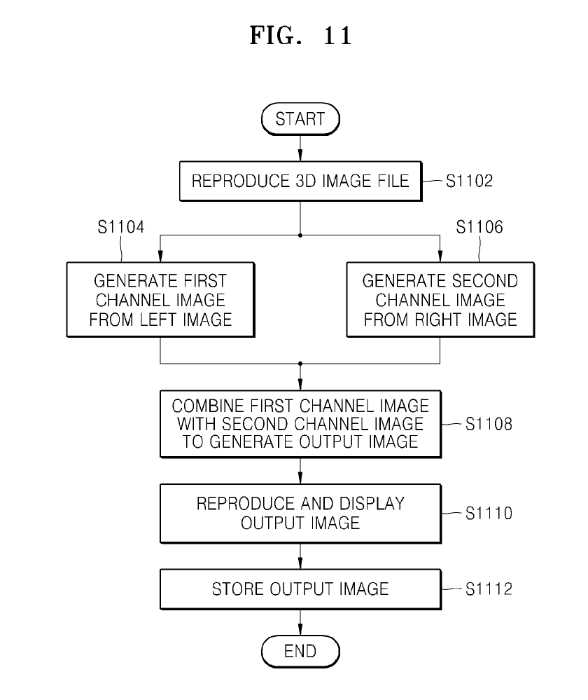

FIG. 11 is a flowchart illustrating an image reproducing method according to yet another embodiment.

The image reproducing method according to the current embodiment reproduces a 3D image file to obtain a left image and a right image in operation S1102. Also, RGB images for the left image and the right image may be obtained.

The image reproducing method includes generating a first channel image from the left image in operation S1104 and generating a second channel image from the right image in operation S1106. According to an embodiment, the first channel image is an image representing a red component of the left image and the second channel image is an image representing a green component and a blue component of the right image.

The image reproducing method includes combining the first channel image with the second channel image to generate an output image in operation S1108.

The image reproducing method includes reproducing and displaying the output image in operation S1110. The image reproducing method also includes generating a file of the output image and storing the generated file in a storage medium (e.g., the storing unit 1010) in operation S1112.

As described above, according to the one or more of the above embodiments, a 3D image may be reproduced in any image reproducing apparatus.

Moreover, according to the embodiments, when a 3D image is reproduced, color or display quality may be improved.

All references, including publications, patent applications, and patents, cited herein are hereby incorporated by reference to the same extent as if each reference were individually and specifically indicated to be incorporated by reference and were set forth in its entirety herein.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. An image reproducing method comprising:
reproducing a three-dimensional (3D) image file including a left image and a right image;
generating a first channel image from the left image of the 3D image;
generating a second channel image from the right image of the 3D image;
combining the first channel image with the second channel image to generate an output image; and
displaying the output image.

2. The image reproducing method of claim 1, wherein the first channel image is an image representing a red component of the left image, and the second channel image is an image representing a green component and a blue component of the right image.

3. The image reproducing method of claim 1, wherein a display device for displaying the output image is a display device for two-dimensional (2D) image reproduction.

4. The image reproducing method of claim 1, further comprising adjusting at least one of a color component and a chroma component of the left image and the right image.

5. The image reproducing method of claim 1, wherein the generating of the output image comprises:
adjusting a weight value for the first channel image and a weight value for the second channel image based on a user setting value; and
combining the first channel image with the second channel image based on the adjusted weight values.

6. The image reproducing method of claim 1, further comprising storing the output image.

7. The image reproducing method of claim 6, wherein the storing of the output image comprises storing information about the 3D image file, together with the output image.

8. An image reproducing apparatus comprising:
a three-dimensional (3D) image reproducing unit configured to reproduce a 3D image file including a left image and a right image;
an image converting unit configured to generate a first channel image from the left image of the 3D image and generate a second channel image from the right image of the 3D image;
an image combining unit configured to combine the first channel image with the second channel image to generate an output image; and
a display unit configured to display the output image.

9. The image reproducing apparatus of claim 8, wherein the first channel image is an image representing a red component of the left image, and the second channel image is an image representing a green component and a blue component of the right image.

10. The image reproducing apparatus of claim 8, wherein the display unit is a display unit for two-dimensional (2D) image reproduction.

11. The image reproducing apparatus of claim 8, wherein the image converting unit adjusts at least one of a color component and a chroma component of the left image and the right image.

12. The image reproducing apparatus of claim 8, wherein the image combining unit adjusts a weight value for the first channel image and a weight value for the second channel image based on a user setting value and combines the first channel image with the second channel image based on the adjusted weight values.

13. The image reproducing apparatus of claim 8, further comprising a storing unit configured to store a file of the output image.

14. The image reproducing apparatus of claim 13, wherein the storing unit stores information about the 3D image file, together with the output image.

15. A non-transitory computer-readable recording medium having recorded thereon computer program codes for executing an image reproducing method when the computer program codes are read and executed by a processor, the image reproducing method comprising:
reproducing a three-dimensional (3D) image file including a left image and a right image;
generating a first channel image from the left image of the 3D image;
generating a second channel image from the right image of the 3D image;
combining the first channel image with the second channel image to generate an output image; and
displaying the output image.

16. The non-transitory computer-readable recording medium of claim 15, wherein the first channel image is an image representing a red component of the left image, and the second channel image is an image representing a green component and a blue component of the right image.

17. The non-transitory computer-readable recording medium of claim 15, wherein a display device for displaying the output image is a display device for two-dimensional (2D) image reproduction.

18. The non-transitory computer-readable recording medium of claim 15, wherein the image reproducing method further comprises adjusting at least one of a color component and a chroma component of the left image and the right image.

19. The non-transitory computer-readable recording medium of claim 15, wherein the generating of the output image comprises:
adjusting a weight value for the first channel image and a weight value for the second channel image based on a user setting value; and
combining the first channel image with the second channel image based on the adjusted weight values.

20. The non-transitory computer-readable recording medium of claim 15, wherein the image reproducing method further comprises storing the output image.
